(19) United States
(12) Patent Application Publication
(10) Pub. No.: US 2003/0012725 A1
(43) Pub. Date: Jan. 16, 2003

(54) Method of making high repetition rate excimer laser crystal optics and UV<200NM transmitting optical fluoride crystal

(76) Inventors: Sandra L. Gray, Horseheads, NY (US); Michael A. Pell, Fountainebleau (FR); Charlene M. Smith, Corning, NY (US); Robert W. Sparrow, Sturbridge, MA (US); Paul M. Then, Corning, NY (US)

Correspondence Address: CORNING INCORPORATED, SP-TI-3-1, CORNING, NY, 14831

(21) Appl. No.: 10/087,146

(22) Filed: Mar. 1, 2002

Related U.S. Application Data
(60) Provisional application No. 60/272,814, filed on Mar. 2, 2001.
(60) Provisional application No. 60/356,987, filed on Feb. 13, 2002.

(51) Int. Cl. G02B 1/00; B29D 11/00; C01F 5/24; C01F 11/18; C01D 3/02; C01F 5/28; C01F 11/22

(52) U.S. Cl. 423/490; 423/430; 264/1.23

(57) ABSTRACT

The invention provides a method of making ≧4 kHz repetition rate argon fluoride excimer laser crystal optics. The method includes providing a magnesium fluoride crystal solid precursor, nonmetallically crushing the magnesium fluoride solid precursor to provide a crushed low metal contaminant magnesium fluoride feedstock, providing a magnesium fluoride crystal growth crucible, loading the crushed magnesium fluoride feedstock into the crystal growth crucible, melting the loaded crushed magnesium fluoride feedstock to provide a precrystalline magnesium fluoride melt, growing an oriented magnesium fluoride crystal from the precrystalline magnesium fluoride melt, cooling the grown magnesium fluoride crystal to provide a magnesium fluoride laser optical crystal and forming the magnesium fluoride laser crystal into an excimer laser crystal optic for transmitting a high repetition rate (≧4 kHz repetition rate) excimer laser output.

### CROSS-REFERENCE TO RELATED APPLICATIONS

This application claims the benefit of, and incorporates by reference, U.S. Provisional Application, Attorney Docket No. SP02-030P filed Feb. 13, 2002 entitled HIGH REPETITION RATE EXCIMER LASER SYSTEM, by M. Pell, C. M. Smith, R. W. Sparrow and P. M. Then.

It also claims the benefit of, and incorporates by reference, U.S. Provisional Application, Serial No. 60/272,814, filed Mar. 2, 2001 entitled HIGH REPETITION RATE UV EXCIMER LASER MAGNESIUM FLUORIDE OPTICS, by R. W. Sparrow.

It also claims the benefit of, and incorporates by reference, co-filed U.S. Non-Provisional Application, Attorney Docket No. SP01-033A, entitled HIGH REPETITION RATE EXCIMER LASER SYSTEM, by M. Pell, C. M. Smith, R. W. Sparrow and P. M. Then.

### FIELD OF THE INVENTION

The present invention relates generally to UV transmitting optical fluoride crystals, and particularly to high repetition rate excimer laser optical magnesium fluoride crystals.

### TECHNICAL BACKGROUND

The invention includes a making magnesium fluoride laser optics for transmitting and controlling the UV λ photons produced by a high repetition rate (repetition rate ≧4 kHz) fluoride excimer laser. The magnesium fluoride high repetition rate UV excimer laser optics provide for improved reliability in the operation of ≧4 kHz high repetition rate laser systems. The magnesium fluoride containing high repetition rate laser provides for the production of a high laser power (≧10 mJ) output at a high repetition rate (≧4 kHz) for a long laser system operation time (>500 million pulses, preferably ≧900 million pulses) with a magnesium fluoride laser optics reliability that avoids catastrophic damage of the laser optics and related catastrophic laser system failure. In a preferred embodiment the magnesium fluoride laser optics are utilized in a UV λ<200 nm ArF excimer laser with a 4 kHz repetition rate and an output power of 10 mJ.

The manufacture of semiconductor chips can be achieved using excimer lasers as a light source. Krypton Fluoride lasers with a wavelength of ˜248 nm were the first excimer lasers to be used. As the semi-conductor chip technology has evolved, lasers of higher energy and higher repetition rate are required. One such excimer laser is known as Argon Fluoride emitting at ˜193 nm. For various applications it is preferable to have such a laser with a repetition rate of 4 kHz. At high repetition rates such as 4 kHz it has been observed that optical fluoride crystal chamber windows can suffer catastrophic damage in a relatively short time scale [less than 500 million pulses for a 4 kHz, 193 nm ArF laser with an output power of 10 mJ.] The damage to the optical fluoride crystal window can be as severe as cracking but at a minimum results in wavefront distortion and increased birefringence. Changing of the optical fluoride crystal windows results in an increased cost of operation of the laser and therefore increased cost of ownership for the chip manufacturer.

The invention includes making magnesium fluoride crystals for transmitting less than 200 nm UV light. The invention includes making magnesium fluoride crystals optics for lithographic ˜193 nm (centered about 193 nm) excimer lasers that operate at a high repetition rate of at least 4 kHz with the magnesium fluoride crystals suitably oriented to minimize the effects of the intrinsic birefringence of magnesium fluoride. The ≧4 kHz lithographic 193 nm excimer laser magnesium fluoride crystal optics provide the benefits of longer lifetime and improved performance of the optics leading to a reduced cost of ownership of a lithographic 193 nm excimer lasers. The invention provides λ<200 nm optical fluoride crystals for transmitting UV λ<200 nm with the λ<200 nm optical fluoride crystals. The invention includes making optical fluoride excimer laser crystals and optics for transmitting UV wavelengths ≦193 nm.

### SUMMARY OF THE INVENTION

One aspect of the invention relates to a method of making an excimer laser crystal optic, preferably a ≧4 kHz repetition rate argon fluoride excimer laser crystal optic. The method includes providing a magnesium fluoride crystal solid precursor, nonmetallically crushing the magnesium fluoride solid precursor to provide a crushed low metal contaminant magnesium fluoride feedstock, providing a c axis oriented magnesium fluoride seed crystal, providing a magnesium fluoride crystal growth crucible having a seed crystal reservoir for receiving an oriented seed crystal, inserting the c axis oriented magnesium fluoride seed crystal into the crystal growth crucible seed crystal reservoir, loading the crushed magnesium fluoride feedstock into the crystal growth crucible, melting the loaded crushed magnesium fluoride feedstock to provide a precrystalline magnesium fluoride melt, growing a c axis oriented magnesium fluoride crystal from the precrystalline magnesium fluoride melt, cooling the grown magnesium fluoride crystal to provide a magnesium fluoride laser optical crystal with a 42 mm crystal 120 nm transmission of at least 30% and forming the magnesium fluoride laser crystal into an excimer laser crystal optic. Preferably the excimer laser crystal optic is a high repetition rate (≧4 kHz repetition rate) excimer laser crystal optic for transmitting a high repetition rate (≧4 kHz repetition rate) excimer laser output.

In another embodiment, the present invention includes a method of making a magnesium fluoride optical crystal. The method includes providing a magnesium fluoride crystal solid precursor, nonmetallically crushing the magnesium fluoride solid precursor to provide a crushed low metal contaminant magnesium fluoride feedstock, providing a magnesium fluoride crystal growth crucible, loading the crushed magnesium fluoride feedstock into the crystal growth crucible, melting the loaded crushed magnesium fluoride feedstock to provide a precrystalline magnesium fluoride melt, growing a magnesium fluoride crystal from the precrystalline magnesium fluoride melt, and cooling the grown magnesium fluoride crystal to provide a magnesium fluoride optical crystal.

In another embodiment, the present invention includes a method of making an optical fluoride crystal. The method includes providing a fluoride crystal solid precursor, nonmetallically crushing the fluoride solid precursor to provide a crushed low metal contaminant fluoride crystal feedstock, providing a fluoride crystal growth crucible, loading the crushed fluoride crystal feedstock into the crystal growth crucible, melting the loaded crushed fluoride crystal feedstock to provide a precrystalline fluoride melt, growing a fluoride crystal from the precrystalline fluoride melt, and cooling the grown fluoride crystal to provide an optical fluoride crystal.

Additional features and advantages of various embodiments of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 shows an embodiment of the present invention;

FIG. 2 shows an embodiment of the present invention;

FIG. 3 shows an embodiment of the present invention;

FIG. 4 shows an embodiment of the present invention;

FIG. 5a-c show an embodiment of the present invention;

FIGS. 6-11 show an embodiment of the present invention;

FIG. 12 shows an embodiment of the present invention;

FIG. 13 shows an embodiment of the present invention;

FIG. 14 shows an embodiment of the present invention;

FIG. 15 shows an embodiment of the present invention;

FIG. 16 shows an embodiment of the present invention;

FIG. 17 shows an embodiment of the present invention; and

FIG. 18 shows an embodiment of the present invention.

### DETAILED DESCRIPTION OF THE PREFERRED EMBODIMENTS

Reference will now be made in detail to the present preferred embodiments of the invention, examples of which are illustrated in the accompanying drawings.

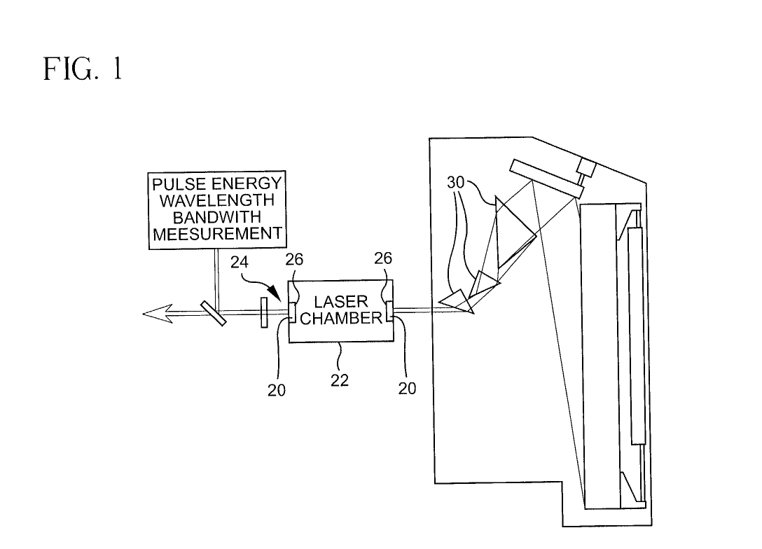

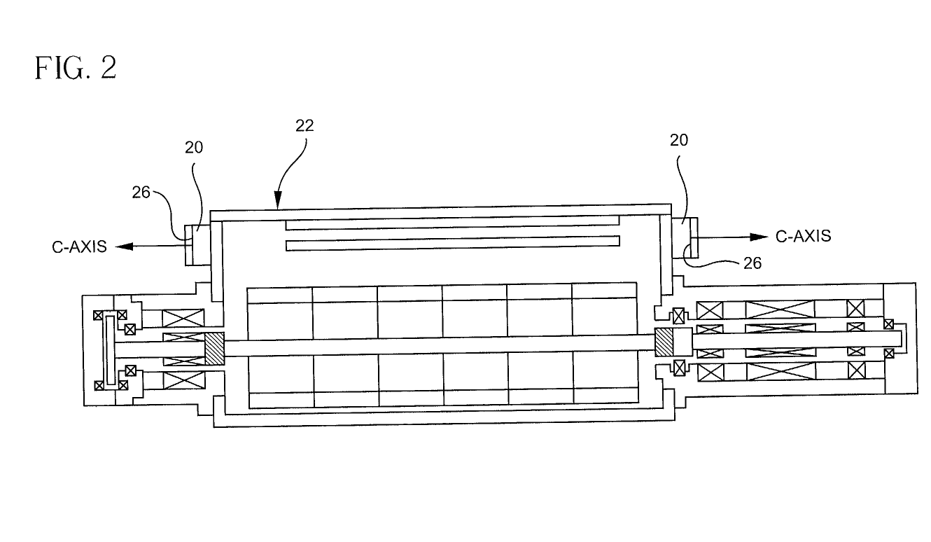

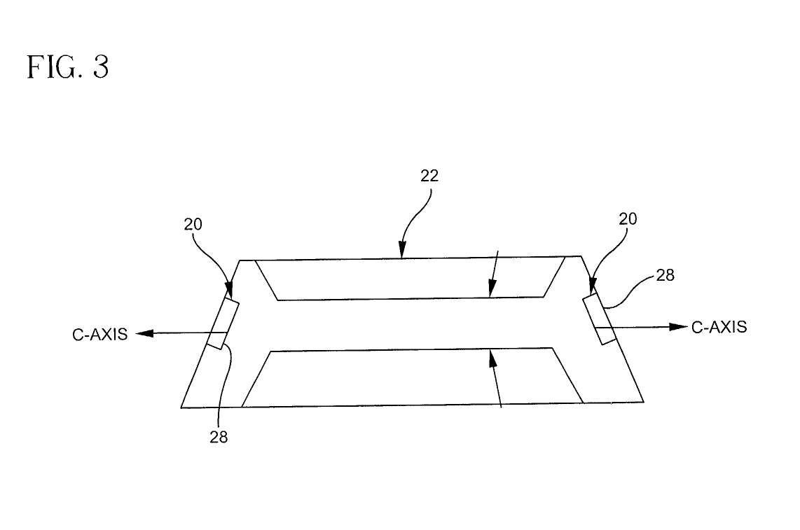

The invention includes a method of making an excimer laser crystal optic. Preferably the method comprises making ≧4 kHz repetition rate argon fluoride excimer laser crystal optics. FIGS. 1-3 show embodiments of ≧4 kHz repetition rate argon fluoride excimer laser systems. Excimer laser chamber 22 includes two magnesium fluoride crystal optic windows 20 for outputting the laser discharge produced in laser chamber 22. In a preferred embodiment, magnesium fluoride crystal laser chamber window 20 has a flat planar window face oriented normal to the c axis of the magnesium fluoride crystal. As shown in FIGS. 1-2, flat planar window faces 26 of chamber windows 20 are substantially normal to the magnesium fluoride crystal c axis crystallographic orientation, with the outputted 193 nm excimer laser light rays substantially parallel to the crystal c axis. In an alternatively preferred embodiment, magnesium fluoride crystal laser chamber window 20 has a flat planar window face oriented non-normal to the c axis of the magnesium fluoride crystal. As shown in FIG. 3, flat planar window faces 28 of chamber windows 20 are non-normal to the magnesium fluoride crystal c axis crystallographic orientation, with the outputted excimer laser light rays outputted from excimer laser chamber 22 substantially parallel to the crystal c axis. FIG. 1 shows an embodiment with three magnesium fluoride crystal optic prisms 30 which transmit and control the photons outputted from laser chamber 22 through magnesium fluoride crystal optic window 20. Magnesium fluoride crystal optic prisms 30 are excimer laser magnesium fluoride crystal line narrowing module beam expanding prisms. Preferably the excimer laser output is transmitted through prisms 30 substantially parallel to a c axis of the magnesium fluoride crystal optic prism with the light rays substantially parallel with the magnesium fluoride crystal c axis. Preferably magnesium fluoride crystal optic prism 30 has a c axis grown magnesium fluoride crystallographic orientation with the magnesium fluoride crystal grown on a c axis oriented seed crystal.

The method of making an excimer laser crystal optic includes providing a magnesium fluoride crystal solid precursor. Providing a magnesium fluoride crystal solid precursor preferably includes providing a purified magnesium fluoride crystal solid precursor. The purified magnesium fluoride crystal solid precursor is a magnesium fluoride crystalline solid state material, preferably either single crystal or polycrystalline magnesium fluoride that has gone through a purification process subsequent to the chemical synthesis of the magnesium fluoride. In a preferred embodiment the purified magnesium fluoride crystal solid precursor is obtained by purifying and melting a chemically synthesized precipitated magnesium fluoride powder. In a preferred embodiment the purified magnesium fluoride crystal solid precursor is obtained by sublimation of a synthesized magnesium fluoride. Preferably the purified magnesium fluoride crystal solid precursor has been sublimed at least once, more preferably at least twice, with the purified magnesium fluoride crystal solid precursor being condensed into a solid distillate, preferably with the sublimation avoiding contamination condensation of contaminants or from handling after sublimation. In an embodiment the purified magnesium fluoride crystal solid precursor is obtained from pre-melting the magnesium fluoride with a scavenger. In an embodiment the pre-melting of the magnesium fluoride with a scavenger utilizes a solid scavenger such as lead fluoride. Alternatively to solid scavenger fluorine containing gas scavengers, such as CF₄, are utilized to obtain the purified magnesium fluoride crystal solid precursor, such as by gas scavenging before and/or during melting of a chemically synthesized precipitated magnesium fluoride.

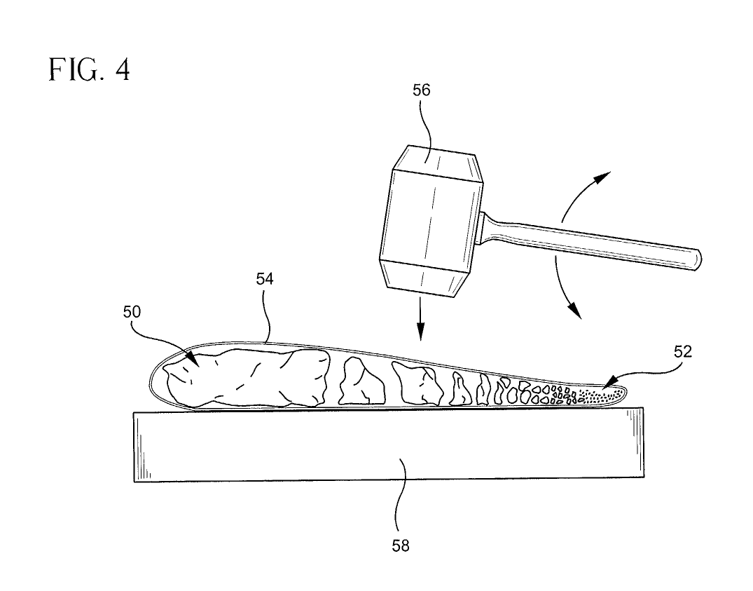

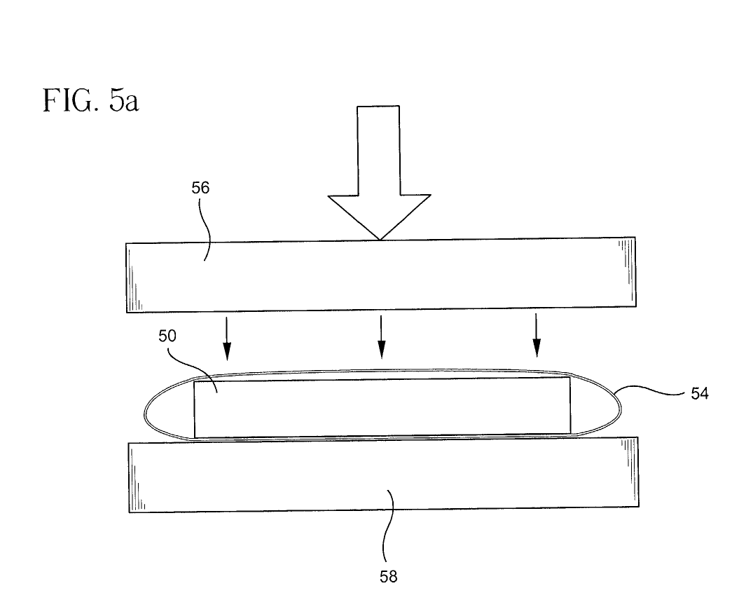

The method of making an excimer laser crystal optic includes nonmetallically crushing the magnesium fluoride solid precursor to provide a crushed low metal contaminant magnesium fluoride feedstock. Nonmetallically crushing the magnesium fluoride solid precursor includes inhibiting contact with metallic surfaces which can result in metal contamination of the magnesium fluoride. Nonmetallically crushing the provided magnesium fluoride solid precursor provides a crushed purified magnesium fluoride feedstock with minimized metal contaminant levels. The crushed low metal contaminant magnesium fluoride feedstock is then melted into a precrystalline magnesium fluoride melt. As shown in FIGS. 4-5c, magnesium fluoride solid precursor 50 is nonmetallically crushed into magnesium fluoride feedstock 52. Preferably nonmetallically crushing magnesium fluoride solid precursor 50 includes containing the magnesium fluoride within a flexible nonmetallic container while crushing. In a preferred embodiment the magnesium fluoride solid precursor and the crushed magnesium fluoride feedstock are contained in a flexible nonmetallic durable polymeric plastic bag during the nonmetallically crushing, such as with an appropriately sized plastic bag (preferably at least 12 inch long by 12 inch wide, preferably at least about 30 cm by 30 cm) with a thickness of at least 5 mil, most preferably ≧8 mil thickness. Preferably the magnesium fluoride solid precursor is crushed into feedstock pieces having a large diameter <1 inch (2.54 cm), more preferably <¾inch (1.9 cm), more preferably <½inch (1.3 cm), more preferably <1 cm, most preferably no greater than about ¼inch ×¼inch ×¼inch (crushed piece large dimension no greater than about 0.635 cm). As shown in FIG. 4 a nonmetallic wooden mallet can be used to apply a nonmetallic crushing impact force to crush the magnesium fluoride solid precursor. As shown in FIG. 5a-c crusher impactor 56 is utilized to crush the magnesium fluoride solid precursor supported on nonmetallic crusher base 58. In a preferred embodiments the nonmetallic crusher impactor 56 and nonmetallic crusher base 58 are formed from a durable hard nonmetallic material, such as hard wood or the MgF₂ crystalline material itself. The impacting crushing force may be applied with air pressure as with an air hammering process, with hydraulic pressure, freefall weight impact force, or other appropriate repetitive crushing forces. Preferably nonmetallically crushing magnesium fluoride solid precursor 50 into magnesium fluoride feedstock 52 includes providing a nonmetallic crusher, such as wooden mallet, wooden holder/plate, a hardwood crusher, crystal mallet. Most preferably nonmetallically crushing the magnesium fluoride solid precursor includes containing magnesium fluoride within a flexible nonmetallic container and applying a nonmetallic crushing force to said solid precursor through said flexible nonmetallic container.

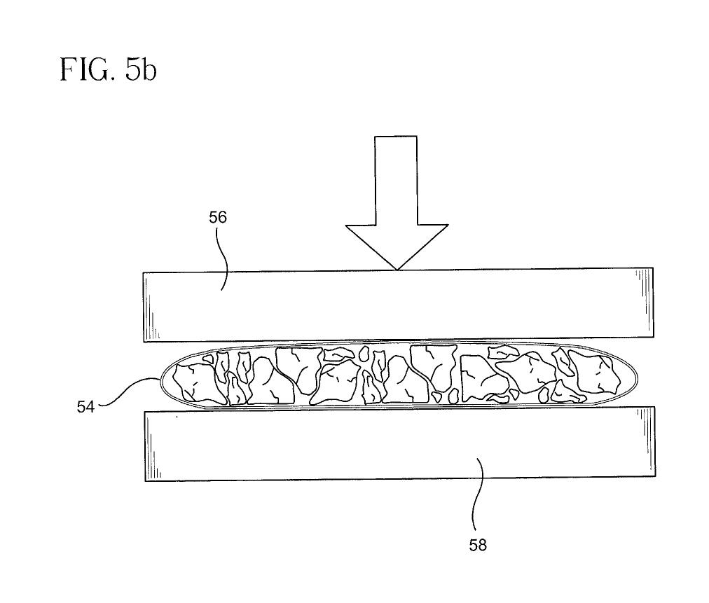

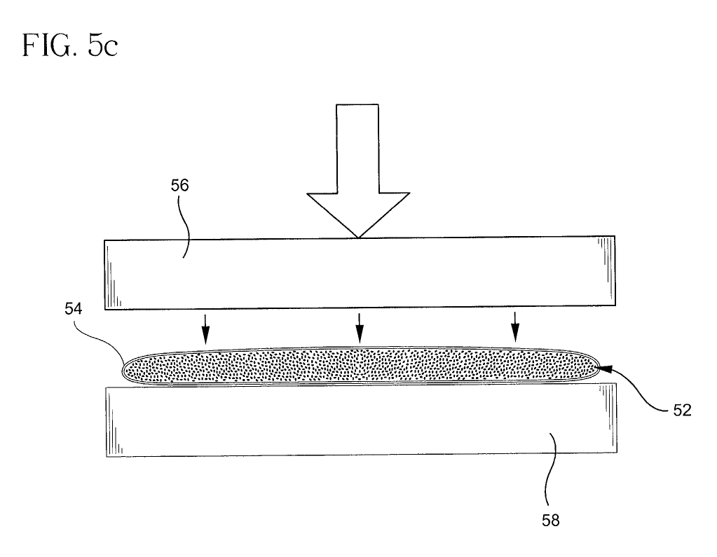

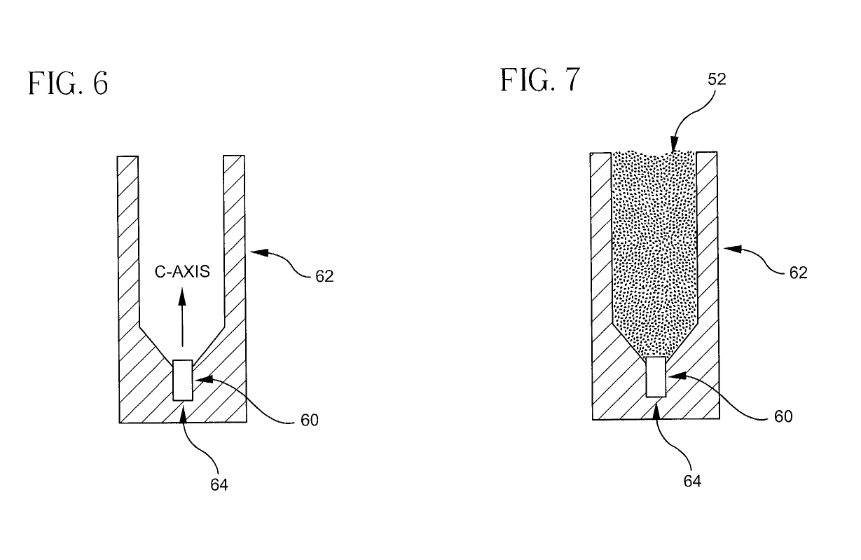

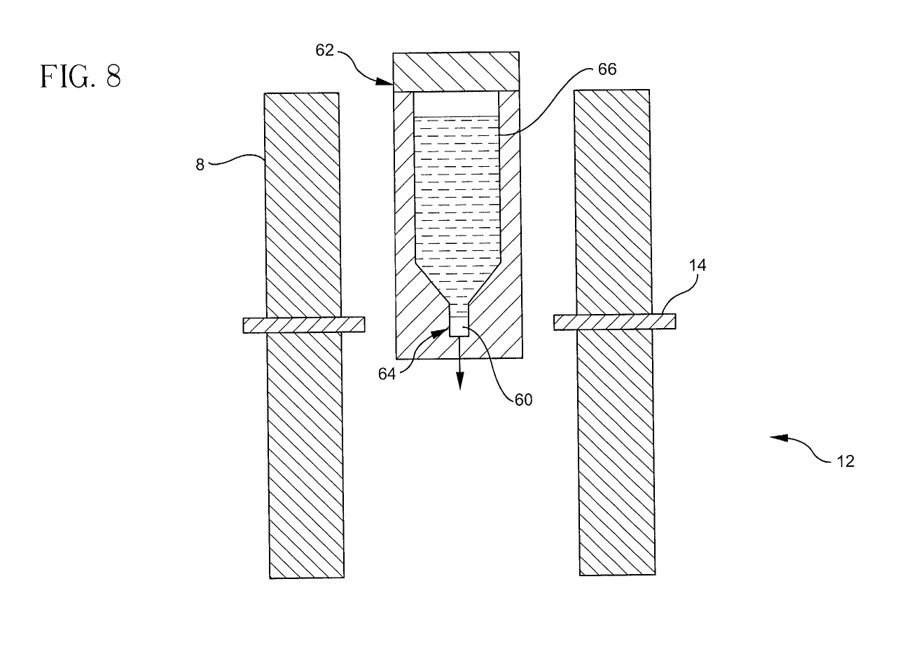

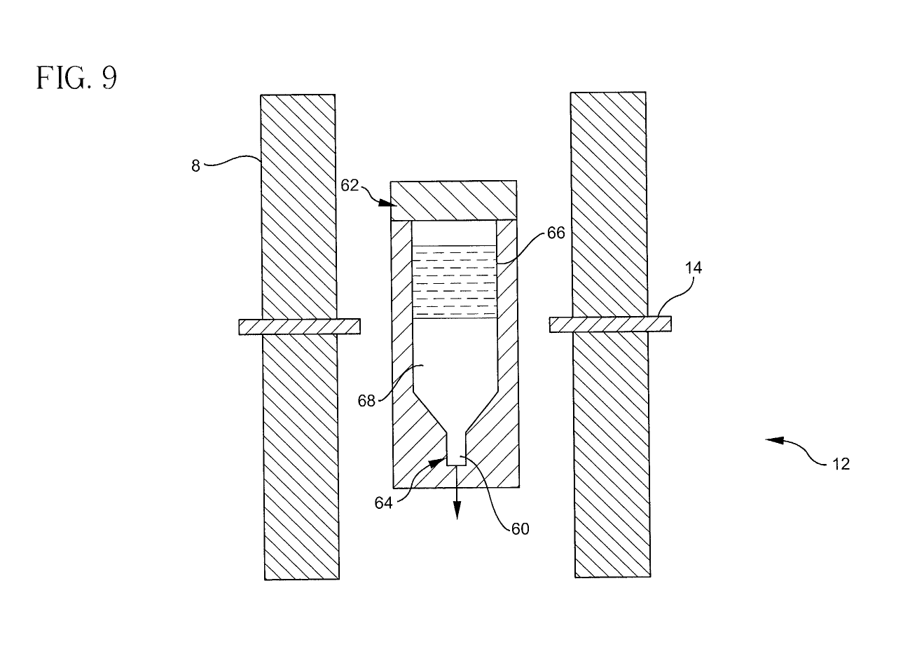

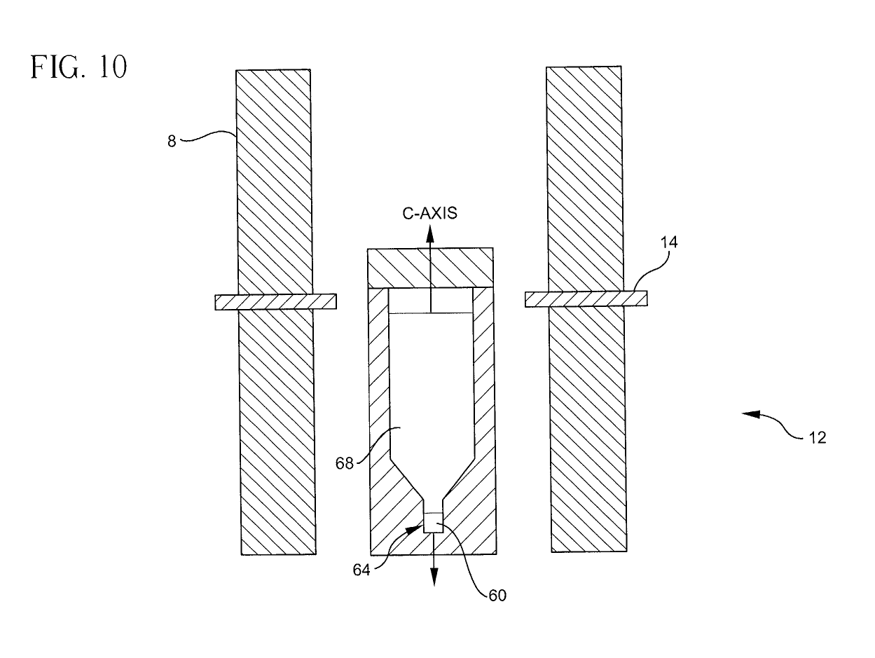

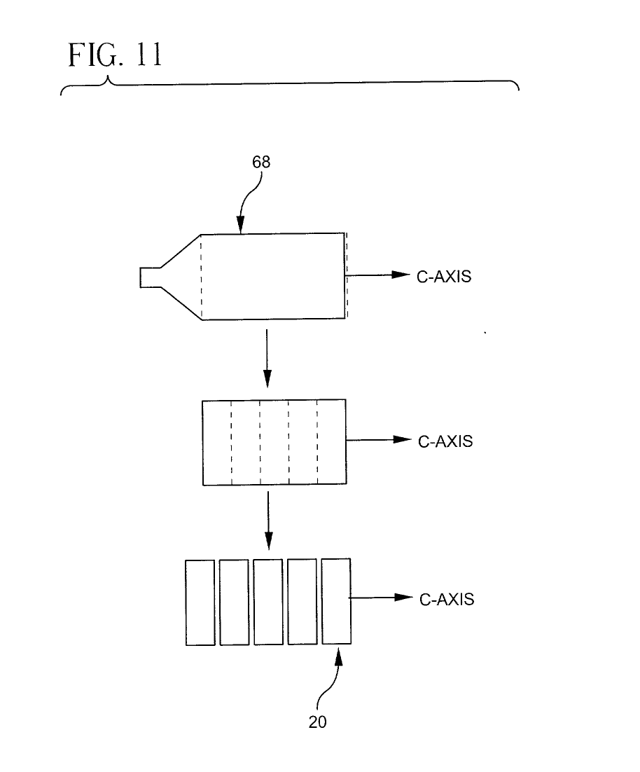

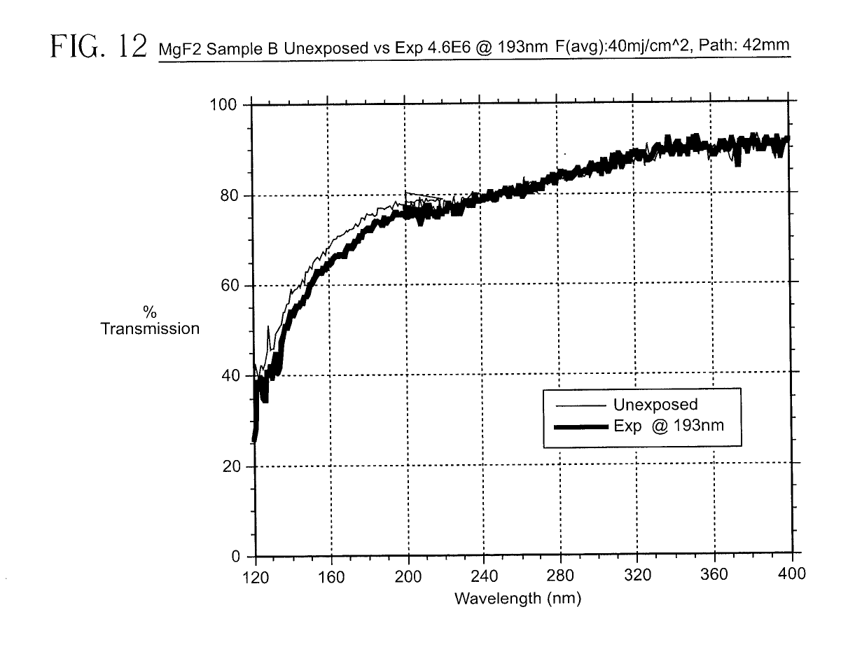

The method of making an excimer laser crystal optic includes providing a c axis oriented magnesium fluoride seed crystal, providing a magnesium fluoride crystal growth crucible having a seed crystal reservoir for receiving a seed crystal, and inserting the c axis oriented magnesium fluoride seed crystal into the crystal growth crucible seed crystal reservoir. As shown in FIG. 6 a c axis oriented magnesium fluoride seed crystal 60 is inserted into seed crystal reservoir 64 of magnesium fluoride crystal growth crucible 62 to provide for the growing of a c axis oriented crystal in the crucible based on the seed crystals orientation. As shown in FIG. 7, the method includes loading the crushed magnesium fluoride feedstock 52 into the crystal growth crucible 62. In a preferred embodiment the crystal growth crucible is comprised of graphite. The loaded crushed magnesium fluoride feedstock 52 in crystal growth crucible 62 is melted in a crystal growth furnace and then grown into a crystal, preferably in a vacuum atmosphere Stockbarger crystal growth furnace, such as the vacuum/controlled-atmosphere Stockbarger crystal growth furnaces shown in FIGS. 8-10, 14-17. The method includes melting the loaded crushed magnesium fluoride feedstock 52 to provide a precrystalline magnesium fluoride melt 66 and growing a c axis oriented magnesium fluoride crystal 68 from the precrystalline magnesium fluoride melt 66, cooling the grown magnesium fluoride crystal 68 in the crucible and furnace to provide a magnesium fluoride laser optical crystal 70 with a 42 mm crystal 120 nm transmission of at least 30% and forming the magnesium fluoride laser crystal into an excimer laser crystal optic 20 for transmitting high repetition rate excimer laser outputs. As shown in FIGS. 7-11, loaded crushed magnesium fluoride feedstock 52 in crystal growth crucible 62 is melted to provide a precrystalline magnesium fluoride melt 66, from which is grown a c axis oriented magnesium fluoride crystal 68 by progressively translating the melt 66 through a freezing thermal gradient, which is then slowly cooled to room temperature to provide a magnesium fluoride laser optical crystal 70. The magnesium fluoride laser optical crystal 70 is preferably a high quality magnesium fluoride optical crystal that has optical qualities including a 42 mm crystal 120 nm transmission of at least 30%. In a preferred embodiment the method includes providing a contaminant scavenger and scavenging contaminants from said magnesium fluoride feedstock either prior to or during the melting of the feedstock in the growth crucible. In a preferred embodiment a lead fluoride contaminant scavenger is added to the loaded feedstock with the lead fluoride contaminant scavenger scavenging contaminants from the magnesium fluoride. Preferably between about 0.1-10 wt. % lead fluoride is used, more preferably at least 0.5% lead fluoride contaminant scavenger, and most preferably 0.5% to 2%. Preferably the lead fluoride contaminant scavenger is of high purity with metal contaminant levels less than 1 ppm by weight. In an alternative embodiment the loaded feedstock is scavenged with a fluorine containing gas contaminant scavenger, preferably in the crucible and prior to melting. Preferably melting crushed magnesium fluoride feedstock 52 to provide a precrystalline magnesium fluoride melt 66 also includes melting no more than 90% of c axis oriented magnesium fluoride seed crystal 60, preferably melting no more than about 50% of the seed crystal. Preferably growing magnesium fluoride crystal 68 includes lowering crystal growth crucible 62 and its melt 66 down through a magnesium fluoride crystal growth temperature gradient at a rate no greater than 1 mm per hour. Preferably magnesium fluoride optical crystal 70 and magnesium fluoride laser crystal 20 have 42 mm crystal path length 120 nm transmission of at least 35%, most preferably at least 40%. Preferably magnesium fluoride optical crystal 70 and magnesium fluoride laser crystal 20 have 255 nm induced absorptions less than 0.08 Abs/42 mm when exposed to 5 million pulses of 193 nm light at a fluence ≧40 mj/cm²/pulse. Preferably magnesium fluoride optical crystal 70 and magnesium fluoride laser crystal 20 have 200 to 210 nm range absorption coefficients <0.0017 cm⁻¹. FIGS. 12-13 show VUV/UV plots of the magnesium fluoride optical crystals with optical qualities including 42 mm crystal path length 120 nm transmission of at least 30%, 255 nm induced absorptions less than 0.08 Abs/42 mm when exposed to 5 million pulses of 193 nm light at a fluence ≧40 mj/cm²/pulse, and 200 to 210 nm range absorption coefficients <0.0017 cm⁻¹. Preferably the optical fluoride crystal has a 255 nm induced absorption less than 0.01 Abs/5 mm when exposed to 5 million pulses of 193 nm light at a 40 mj/cm²/pulse fluence. Preferably the crushed low metal contaminant magnesium fluoride feedstock has metal contaminant levels less than 1 ppm by weight, more preferably with the crushed low metal contaminant magnesium fluoride feedstock having transition element metal contaminant levels no greater than 0.7 ppm by weight. Preferably the produced magnesium fluoride optical laser crystal has a Fe contamination level less than 0.15 ppm Fe by weight. Preferably the produced magnesium fluoride optical laser crystal has a chrome contamination level less than 0.06 ppm chrome by weight. Preferably the produced magnesium fluoride optical laser crystal has a copper contamination level less than 0.02 ppm copper by weight. Preferably the produced magnesium fluoride optical laser crystal has a cobalt contamination level less than 0.02 ppm cobalt by weight. Preferably the produced magnesium fluoride optical laser crystal has an Al contamination level less than 0.7 ppm Al by weight. Preferably the produced magnesium fluoride optical laser crystal has a nickel contamination level less than 0.02 ppm nickel by weight. Preferably the produced magnesium fluoride optical laser crystal has a vanadium contamination level less than 0.02 ppm vanadium by weight. Preferably the produced magnesium fluoride optical laser crystal has a lead contamination level less than 0.02 ppm lead by weight. Preferably the produced magnesium fluoride optical laser crystal has a molybdenum contamination level less than 0.02 ppm molybdenum by weight. Preferably the produced magnesium fluoride optical laser crystal has a manganese contamination level less than 0.02 ppm manganese by weight.

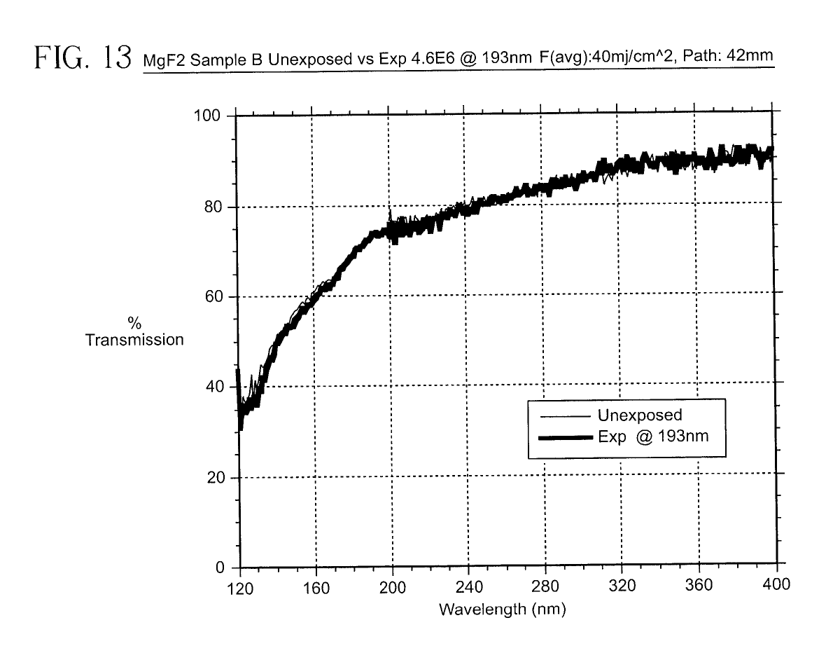

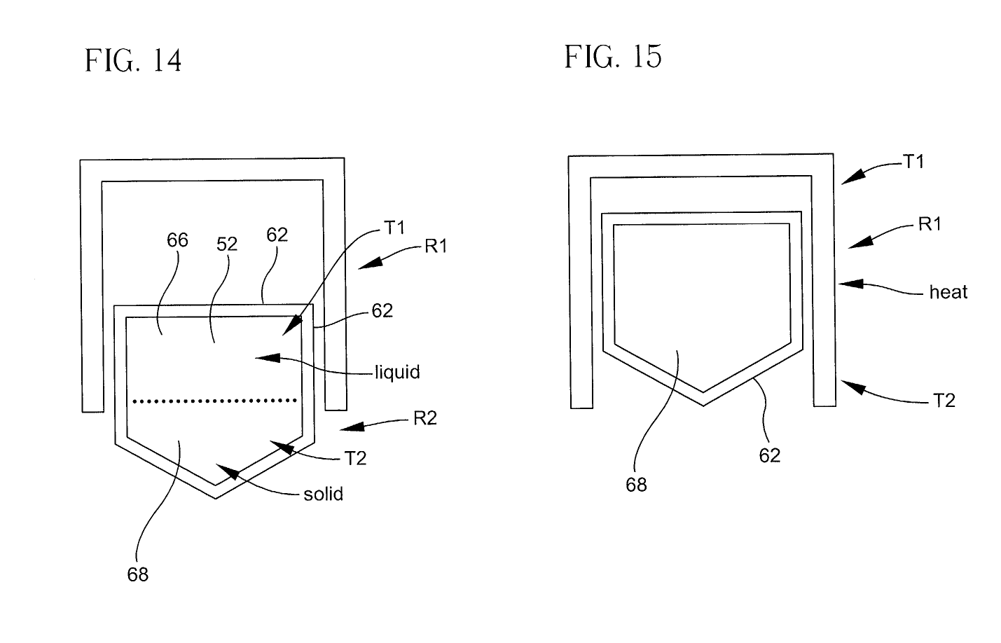

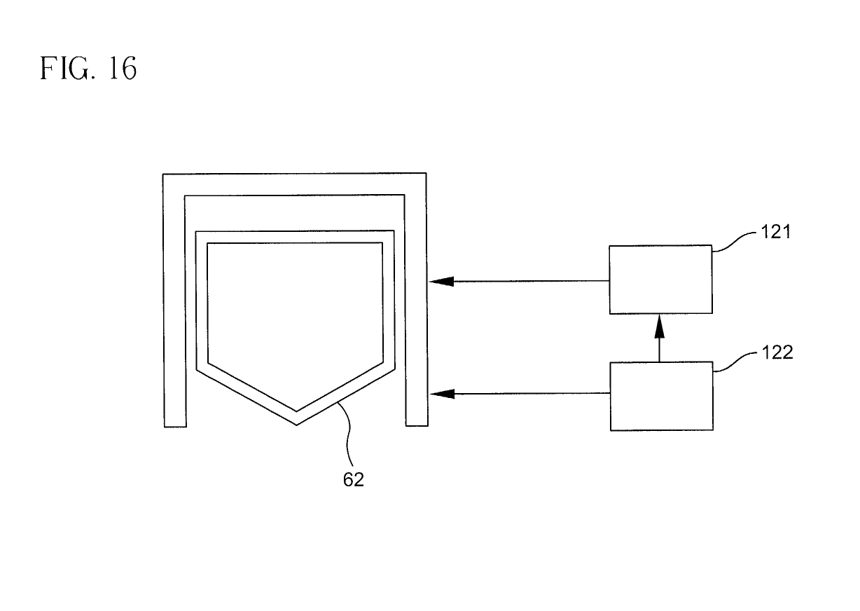

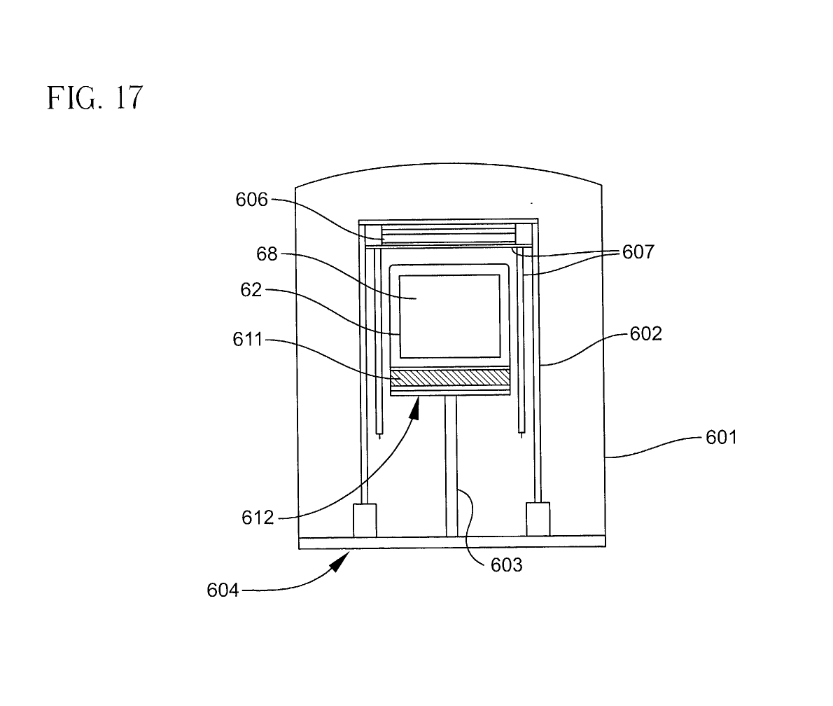

The invention includes a method of making a magnesium fluoride optical crystal by providing a magnesium fluoride crystal solid precursor, nonmetallically crushing the magnesium fluoride solid precursor to provide a crushed low metal contaminant magnesium fluoride feedstock, providing a magnesium fluoride crystal growth crucible, loading the crushed magnesium fluoride feedstock into the crystal growth crucible, melting the loaded crushed magnesium fluoride feedstock to provide a precrystalline magnesium fluoride melt, growing a magnesium fluoride crystal from the precrystalline magnesium fluoride melt, and cooling the grown magnesium fluoride crystal to provide a magnesium fluoride optical crystal. FIGS. 4-11 and 14-17 show the making of a magnesium fluoride optical crystal 70. The method comprises providing a magnesium fluoride crystal solid precursor 50, nonmetallically crushing magnesium fluoride solid precursor 50 to provide a crushed low metal contaminant magnesium fluoride feedstock 52, providing a magnesium fluoride crystal growth crucible 62, loading crushed magnesium fluoride feedstock 52 into crystal growth crucible 62, melting loaded crushed magnesium fluoride feedstock 52 to provide a precrystalline magnesium fluoride melt 66, growing a magnesium fluoride crystal 68 from precrystalline magnesium fluoride melt 66, and cooling grown magnesium fluoride crystal 68 to provide a magnesium fluoride optical crystal 70. Making of the crystal is illustrated in FIGS. 14-15. Crushed low metal contaminant magnesium fluoride feedstock 52 is placed in crucible 62. Feedstock 52 is heated to a liquid phase (about 1350(±30)° C. for MgF₂). The crucible is slowly lowered from the heated region R 1, with the crystal 68 growing in the region R 2 where the liquid can cool below a critical temperature. The difference between the liquid temperature T 1 and crystal temperature T 2 leads to a temperature gradient across the crystal/liquid combination. Once the crystal growth phase is complete, the crystal is slowly cooled from a high furnace temperature to room temperature to allow thermal equilibrium of the crystal and avoid thermally straining the crystal. Preferably cooling the crystal includes annealing the crystal. Preferably the magnesium fluoride crystal is allowed to reach a thermal equilibrium of about 900 to 1000° C. for about 24 hours. FIG. 15 shows an embodiment of the crystal annealing process. In FIG. 15 the crystal is placed back in the heated region R 1, but the temperature is less than that required to liquefy the crystal. The crystal loses heat through its top, bottom, and sides. The temperature of the crystal is slowly reduced until it reaches a certain value, typically room temperature (annealing a crystal can take up to approximately 30 days to bring the temperature from 1000° C. to 50° C., at cooling rates of less than 1° C. per hour). The temperature of the crystal is slowly reduced, conventionally still with a vertical temperature gradient as represented by differences between T 1 and T 2. After the crystal is completely cooled, typically the ends are cut off to produce a magnesium fluoride optical crystal. The magnesium fluoride optical crystal can then be ground, shaped, cut and/or polished to produce an optical element such as a lens, window, or prism. In an embodiment the method can include maintaining a minimal temperature gradient across the crystal while slowly reducing the bulk temperature of the crystal. In an embodiment a thermal control system can be utilized to provide a temperature gradient during crystal growth but minimizes the temperature gradient during crystal cooling. In an embodiment a secondary heater below the crucible is used. The secondary heater supplies heat to minimize the temperature gradients in the crystal during the cooling annealing process. The secondary heater can mount near the bottom of the crucible to effectively maintain appropriate temperature gradients. It is especially important to maintain a low temperature gradient during the initial cooling phase when the hot crystal has relatively low yield strength. As shown in FIG. 17 a primary heating system mounted near the top and sides of the crystal 68, and a secondary heating system mounted near the bottom of the crystal allows for supplying heat using the primary and secondary heating systems to maintain the crystal's temperature at a decreasing value over time. An embodiment is shown schematically in FIG. 16. A heat source 121 can maintain the high temperature needed for melting and crystal growth. Once the growth phase is complete, a thermal control system 122 maintains the crystal at a substantially uniform temperature during annealing. Thermal control system 122 maintains the vertical temperature gradient within limits appropriate for the crystal material. Thermal control system 122 gradually reduces the temperature of the crystal during annealing without allowing a temperature gradient beyond the bounds. Thermal control system can be implemented in various ways that will be apparent to those skilled in the art, including by radiant heating elements appropriately spaced proximal the crystal, insulation, inductive heaters, monitoring and control systems, and combinations thereof. FIG. 17 shows an embodiment in a sectional view. The crystal growth furnace includes furnace wall 601, support structure 602, crucible support column 603, base 604, crucible 62, primary heat shields 606, and primary heaters 607, secondary heater 611 and secondary heat shields 612. Secondary heater 611 can be active, supplying heat, during the crystal annealing phase. Secondary heater 611 can operate in conjunction with primary heaters 607, supplying heat from below a crystal being annealed. The multiple heat sources provide the temperature profile required for annealing without allowing uneven heat loss that can lead to large temperature gradients. The power required from primary heaters 607 and secondary heater 611 is related to the furnace dimensions, crystal material characteristics, heat shield performance, and crucible dimensions. As an example, crucible 605 can be about 8 inches in diameter. Furnace wall 601 can define a volume about 20 to 40 inches in diameter and about 40 inches high. At the onset of annealing primary heaters 607 can supply about 6 kW and secondary heater 611 about 3.5 kW. The power in primary heaters 607 and secondary heater 611 can be reduced, for example linearly, during annealing. Primary 606 and secondary heat shields 612 can be of graphite, ¼to ½inch thick. Preferably the internal radial diameter size of the elongated crystal growth crucible is proximate the required large dimension size of the optic formed from the magnesium fluoride optical crystal so that the crystal radial diameter produced in the crucible is a near net shape dimension, preferably with the internal diameter size of the crystal growth crucible no more than 40% greater than the optical fluoride crystal optic large dimension (diameter), more preferably the internal diameter size of the crystal growth crucible no more than about 30% greater, more preferably the internal diameter size of the crystal growth crucible no more than about 20% greater, most preferably the internal diameter size of the crystal growth crucible is no more than about 10% greater (prefer 5 to 10% greater) than the optical fluoride crystal optic large dimension (diameter) formed from the fluoride optical crystal in the crucible. The method of making a magnesium fluoride optical crystal preferably includes providing a purified magnesium fluoride crystal solid precursor. The method of making a magnesium fluoride optical crystal preferably includes containing said magnesium fluoride within a flexible nonmetallic container while crushing. The method of making a magnesium fluoride optical crystal preferably includes providing a nonmetallic crusher. The method of making a magnesium fluoride optical crystal preferably includes containing said magnesium fluoride within a flexible nonmetallic container and applying a nonmetallic crushing force to said solid precursor through said flexible nonmetallic container. Preferably the crushed low metal contaminant magnesium fluoride feedstock has metal contaminant levels less than 1 ppm by weight, more preferably transition element metal contaminant levels no greater than 0.7 ppm by weight. Preferably the magnesium fluoride optical crystal has a Fe contamination level less than 0.15 ppm Fe by weight, a chrome contamination level less than 0.06 ppm chrome by weight, a copper contamination level less than 0.02 ppm copper by weight, a cobalt contamination level less than 0.02 ppm cobalt by weight, an Al contamination level less than 0.7 ppm Al by weight, a nickel contamination level less than 0.02 ppm nickel by weight, a vanadium contamination level less than 0.02 ppm vanadium by weight, a lead contamination level less than 0.02 ppm lead by weight, a molybdenum contamination level less than 0.02 ppm molybdenum by weight, a manganese contamination level less than 0.02 ppm manganese by weight. Preferably the magnesium fluoride optical crystal has a crystal 120 nm transmission of at least 30% through a 42 mm path length of crystal, more preferably at least 35%, and most preferably at least 40%. Preferably the magnesium fluoride optical crystal has a 255 nm induced absorption less than 0.08 Abs/42 mm when exposed to 5 million pulses of 193 nm light at a fluence ≧40 mj/cm²/pulse. Preferably the optical fluoride crystal has a 255 nm induced absorption less than 0.01 Abs/5 mm when exposed to 5 million pulses of 193 nm light at a 40 mj/cm²/pulse fluence. Preferably the magnesium fluoride optical crystal has an 200 to 210 nm range absorption coefficient <0.0017 cm⁻¹.

The invention includes a method of making an optical fluoride crystal. The method comprises providing a fluoride crystal solid precursor, nonmetallically crushing the fluoride solid precursor to provide a crushed low metal contaminant fluoride crystal feedstock, providing a fluoride crystal growth crucible, loading the crushed fluoride crystal feedstock into the crystal growth crucible, melting the loaded crushed fluoride crystal feedstock to provide a precrystalline fluoride melt, growing a fluoride crystal from the precrystalline fluoride melt, and cooling the grown fluoride crystal to provide an optical fluoride crystal. FIGS. 4-11 and 14-17 show the making of an optical crystal 70. Making an optical fluoride crystal 70 includes providing a fluoride crystal solid precursor 50, nonmetallically crushing fluoride solid precursor 50 to provide a crushed low metal contaminant fluoride crystal feedstock 52, providing a fluoride crystal growth crucible 62, loading crushed fluoride crystal feedstock 52 into crystal growth crucible 62, melting loaded crushed fluoride crystal feedstock 52 to provide a precrystalline fluoride melt 66, growing a fluoride crystal 68 from precrystalline fluoride melt 66, and cooling grown fluoride crystal 68 to provide an optical fluoride crystal. The method of making an optical fluoride crystal preferably includes providing a purified crystal solid precursor. The method of making an optical fluoride crystal preferably includes containing said purified crystal solid precursor within a flexible nonmetallic container while crushing. The method of making an optical fluoride crystal preferably includes providing a nonmetallic crusher. The method of making an optical fluoride crystal preferably includes containing said magnesium fluoride within a flexible nonmetallic container and applying a nonmetallic crushing force to said solid precursor through said flexible nonmetallic container. Preferably the crushed low metal contaminant fluoride feedstock has metal contaminant levels less than 1 ppm by weight, more preferably transition element metal contaminant levels no greater than 0.7 ppm by weight. Preferably the an optical fluoride crystal has a Fe contamination level less than 0.15 ppm Fe by weight, a chrome contamination level less than 0.06 ppm chrome by weight, a copper contamination level less than 0.02 ppm copper by weight, a cobalt contamination level less than 0.02 ppm cobalt by weight, an Al contamination level less than 0.7 ppm Al by weight, a nickel contamination level less than 0.02 ppm nickel by weight, a vanadium contamination level less than 0.02 ppm vanadium by weight, a lead contamination level less than 0.02 ppm lead by weight. Preferably the optical fluoride crystal has a 42 mm crystal 120 nm transmission of at least 30%, more preferably at least 35%, and most preferably at least 40%. Preferably the optical fluoride crystal has a 255 nm induced absorption less than 0.08 Abs/42 mm when exposed to 5 million pulses of 193 nm light at a fluence ≧40 mj/cm²/pulse. Preferably the optical fluoride crystal has a 255 nm induced absorption less than 0.01 Abs/5 mm when exposed to 5 million pulses of 193 nm light at a 40 mj/cm²/pulse fluence. Preferably the optical fluoride crystal has an 200 to 210 nm range absorption coefficient <0.0017 cm⁻¹.

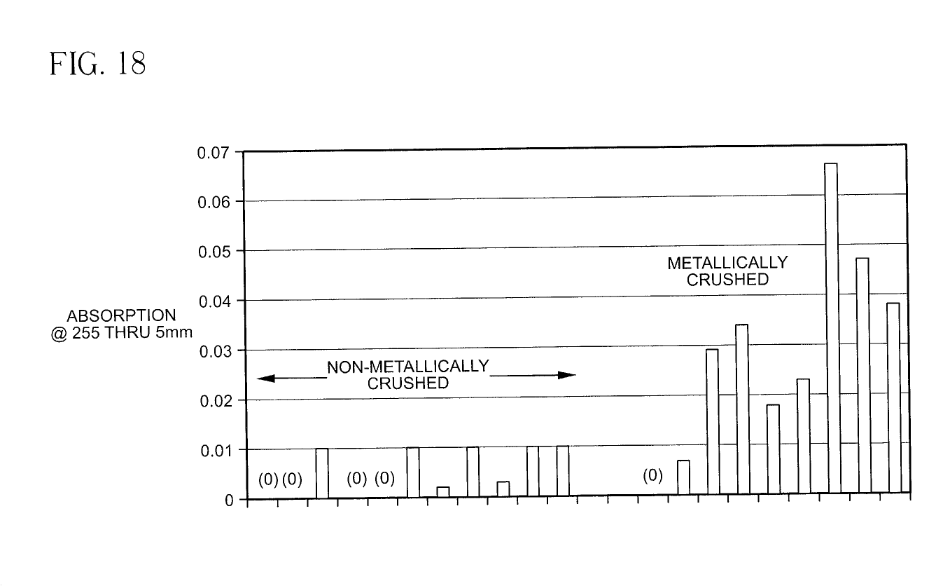

FIG. 18 is a graph of optical fluoride crystal and their 255 nm Absorption after 5 million pulses 193 nm @ 40 mj/cm² through a 5 mm thick path length. The graph show the benefits of nonmetallically crushing the optical fluoride solid precursor to provide a crushed low metal contaminant optical fluoride crystal feedstock. The nonmetallically crushed magnesium fluoride optical crystals on the left where produced by nonmetallically crushing the magnesium fluoride solid precursor inside plastic bags and with wooden mallets. The nonmetallically crushed magnesium fluoride optical fluoride crystal feedstock was then mixed with two lead fluoride scavenger levels (2% and 0.5%) and loaded into the crystal growth crucibles. The comparison optical fluoride magnesium fluoride crystals where produced the same way but using a standard industrial metal containing crusher. FIG. 18 shows the improved crystals with 255 nm induced absorption less than 0.01 Abs/5 mm when exposed to 5 million pulses of 193 nm light at a 40 mj cm²/pulse fluence obtained in accordance with the invention utilizing nonmetallically crushed magnesium fluoride crystal feedstock.

It will be apparent to those skilled in the art that various modifications and variations can be made to the present invention without departing from the spirit and scope of the invention. Thus is intended that the present invention cover the modifications and variations of this invention provided they come within the scope of the appended claims and their equivalents.

1. A method of making an excimer laser crystal optic, said method comprising:
providing a magnesium fluoride crystal solid precursor
nonmetallically crushing said magnesium fluoride solid precursor to provide a crushed low metal contaminant magnesium fluoride feedstock,
providing a c axis oriented magnesium fluoride seed crystal,
providing a magnesium fluoride crystal growth crucible, said crystal growth crucible having a seed crystal reservoir for receiving an oriented seed crystal,
inserting said c axis oriented magnesium fluoride seed crystal into said crystal growth crucible seed crystal reservoir,
loading said crushed magnesium fluoride feedstock into said crystal growth crucible,
melting said loaded crushed magnesium fluoride feedstock to provide a precrystalline magnesium fluoride melt,
growing a c axis oriented magnesium fluoride crystal from said precrystalline magnesium fluoride melt,
cooling said grown magnesium fluoride crystal to provide a magnesium fluoride laser crystal with a 42 mm crystal 120 nm transmission of at least 30%,
and forming said magnesium fluoride laser crystal into an excimer laser crystal optic.

2. A method as claimed in claim 1, wherein providing a magnesium fluoride crystal solid precursor includes providing a purified magnesium fluoride crystal solid precursor.

3. A method as claimed in claim 1, wherein nonmetallically crushing said magnesium fluoride solid precursor includes containing said magnesium fluoride within a flexible nonmetallic container while crushing.

4. A method as claimed in claim 1, wherein nonmetallically crushing said magnesium fluoride solid precursor includes providing a nonmetallic crusher.

5. A method as claimed in claim 1, wherein nonmetallically crushing said magnesium fluoride solid precursor includes containing said magnesium fluoride within a flexible nonmetallic container and applying a nonmetallic crushing force to said solid precursor through said flexible nonmetallic container.

6. A method as claimed in claim 1, said method including providing a contaminant scavenger and scavenging contaminants from said magnesium fluoride.

7. A method as claimed in claim 1, wherein melting said crushed magnesium fluoride feedstock to providing a precrystalline magnesium fluoride melt includes melting no more than 90% of said c axis oriented magnesium fluoride seed crystal.

8. A method as claimed in claim 1, wherein growing a magnesium fluoride crystal includes lowering said crystal growth crucible through a magnesium fluoride crystal growth temperature gradient at a rate no greater than 1 mm per hour.

9. A method as claimed in claim 1, wherein forming said magnesium fluoride laser crystal into an excimer laser crystal optic includes forming said laser crystal into a magnesium fluoride crystal optic window.

10. A method as claimed in claim 1, wherein forming said magnesium fluoride laser crystal into an excimer laser crystal optic includes forming said laser crystal into a magnesium fluoride crystal optic prism.

11. A method as claimed in claim 1, wherein said crushed low metal contaminant magnesium fluoride feedstock has metal contaminant levels less than 1 ppm by weight.

12. A method as claimed in claim 1, wherein said crushed low metal contaminant magnesium fluoride feedstock has transition element metal contaminant levels no greater than 0.7 ppm by weight.

13. A method as claimed in claim 1, wherein said magnesium fluoride laser crystal has a Fe contamination level less than 0.15 ppm Fe by weight.

14. A method as claimed in claim 1, wherein said magnesium fluoride laser crystal has a chrome contamination level less than 0.06 ppm chrome by weight

15. A method as claimed in claim 1, wherein said magnesium fluoride laser crystal has a copper contamination level less than 0.02 ppm copper by weight

16. A method as claimed in claim 1, wherein said magnesium fluoride laser crystal has a cobalt contamination level less than 0.02 ppm cobalt by weight

17. A method as claimed in claim 1, wherein said magnesium fluoride laser crystal has an Al contamination level less than 0.7 ppm Al by weight

18. A method as claimed in claim 1, wherein said magnesium fluoride laser crystal has a nickel contamination level less than 0.02 ppm nickel by weight.

19. A method as claimed in claim 1, wherein said magnesium fluoride laser crystal has a vanadium contamination level less than 0.02 ppm vanadium by weight.

20. A method as claimed in claim 1, wherein said magnesium fluoride laser crystal has a lead contamination level less than 0.02 ppm lead by weight.

21. A method as claimed in claim 1, wherein said magnesium fluoride laser crystal has a molybdenum contamination level less than 0.02 ppm molybdenum by weight.

22. A method as claimed in claim 1, wherein said magnesium fluoride laser crystal has a manganese contamination level less than 0.02 ppm manganese by weight.

23. A method as claimed in claim 1, wherein said magnesium fluoride laser crystal has a 42 mm crystal 120 nm transmission of at least 35%.

24. A method as claimed in claim 1, wherein said magnesium fluoride laser crystal has a 255 nm induced absorption less than 0.08 Abs/42 mm when exposed to 5 million pulses of 193 nm light at a fluence ≧40 mj/cm²/pulse.

25. A method as claimed in claim 1, wherein said magnesium fluoride laser crystal has an 200 to 210 nm range absorption coefficient <0.0017 cm⁻¹.

26. A method of making a magnesium fluoride optical crystal, said method comprising:
providing a magnesium fluoride crystal solid precursor,
nonmetallically crushing said magnesium fluoride solid precursor to provide a crushed low metal contaminant magnesium fluoride feedstock,
providing a magnesium fluoride crystal growth crucible,
loading said crushed magnesium fluoride feedstock into said crystal growth crucible,
melting said loaded crushed magnesium fluoride feedstock to provide a precrystalline magnesium fluoride melt,
growing a magnesium fluoride crystal from said precrystalline magnesium fluoride melt,
cooling said grown magnesium fluoride crystal to provide a magnesium fluoride optical crystal.

27. A method as claimed in claim 26, wherein providing a magnesium fluoride crystal solid precursor includes providing a purified magnesium fluoride crystal solid precursor.

28. A method as claimed in claim 26, wherein nonmetallically crushing said magnesium fluoride solid precursor includes containing said magnesium fluoride within a flexible nonmetallic container while crushing.

29. A method as claimed in claim 26, wherein nonmetallically crushing said magnesium fluoride solid precursor includes providing a nonmetallic crusher.

30. A method as claimed in claim 26, wherein nonmetallically crushing said magnesium fluoride solid precursor includes containing said magnesium fluoride within a flexible nonmetallic container and applying a nonmetallic crushing force to said solid precursor through said flexible nonmetallic container.

31. A method as claimed in claim 26, wherein said crushed low metal contaminant magnesium fluoride feedstock has metal contaminant levels less than 1 ppm by weight.

32. A method as claimed in claim 26, wherein said crushed low metal contaminant magnesium fluoride feedstock has transition element metal contaminant levels no greater than 0.7 ppm by weight.

33. A method as claimed in claim 26, wherein said a magnesium fluoride optical crystal has a Fe contamination level less than 0.15 ppm Fe by weight.

34. A method as claimed in claim 26, wherein said magnesium fluoride optical crystal has a chrome contamination level less than 0.06 ppm chrome by weight

35. A method as claimed in claim 26, wherein said magnesium fluoride optical crystal has a copper contamination level less than 0.02 ppm copper by weight

36. A method as claimed in claim 26, wherein said magnesium fluoride optical crystal has a cobalt contamination level less than 0.02 ppm cobalt by weight

37. A method as claimed in claim 26, wherein said magnesium fluoride optical crystal has an Al contamination level less than 0.7 ppm Al by weight

38. A method as claimed in claim 26, wherein said magnesium fluoride optical crystal has a nickel contamination level less than 0.02 ppm nickel by weight.

39. A method as claimed in claim 26, wherein said magnesium fluoride optical crystal has a vanadium contamination level less than 0.02 ppm vanadium by weight.

40. A method as claimed in claim 26, wherein said magnesium fluoride optical crystal has a lead contamination level less than 0.02 ppm lead by weight.

41. A method as claimed in claim 26, wherein said magnesium fluoride crystal has a molybdenum contamination level less than 0.02 ppm molybdenum by weight.

42. A method as claimed in claim 26, wherein said magnesium fluoride crystal has a manganese contamination level less than 0.02 ppm manganese by weight.

43. A method as claimed in claim 26, wherein said magnesium fluoride optical crystal has a 120 nm transmission of at least 30%.

44. A method as claimed in claim 26, wherein said magnesium fluoride optical crystal has a 255 nm induced absorption less than .08 Abs/42 mm when exposed to 5 million pulses of 193 nm light at a fluence ≧40 mj/cm²/pulse.

45. A method as claimed in claim 26, wherein said magnesium fluoride optical crystal has an 200 to 210 nm range absorption coefficient <0.0017 cm⁻¹.

46. A method of making an optical fluoride crystal, said method comprising:
providing a fluoride crystal solid precursor,
nonmetallically crushing said fluoride solid precursor to provide a crushed low metal contaminant fluoride crystal feedstock,
providing a fluoride crystal growth crucible,
loading said crushed fluoride crystal feedstock into said crystal growth crucible,
melting said loaded crushed fluoride crystal feedstock to provide a precrystalline fluoride melt,
growing a fluoride crystal from said precrystalline fluoride melt,
cooling said grown fluoride crystal to provide an optical fluoride crystal.

47. A method as claimed in claim 46, wherein providing a fluoride crystal solid precursor includes providing a purified fluoride crystal solid precursor.

48. A method as claimed in claim 46, wherein nonmetallically crushing said magnesium fluoride solid precursor includes containing said magnesium fluoride within a flexible nonmetallic container while crushing.

49. A method as claimed in claim 46, wherein nonmetallically crushing said magnesium fluoride solid precursor includes providing a nonmetallic crusher.

50. A method as claimed in claim 46, wherein nonmetallically crushing said magnesium fluoride solid precursor includes containing said magnesium fluoride within a flexible nonmetallic container and applying a nonmetallic crushing force to said solid precursor through said flexible nonmetallic container.

51. A method as claimed in claim 46, wherein said crushed low metal contaminant magnesium fluoride feedstock has metal contaminant levels less than 1 ppm by weight.

52. A method as claimed in claim 46, wherein said crushed low metal contaminant magnesium fluoride feedstock has transition element metal contaminant levels no greater than 0.7 ppm by weight.

53. A method as claimed in claim 46, wherein said optical fluoride crystal has a 120 nm transmission of at least 30%.

54. A method as claimed in claim 46, wherein said optical fluoride crystal has a 255 nm induced absorption less than 0.08 Abs/42 mm when exposed to 5 million pulses of 193 nm light at a fluence ≧40 mj/cm²/pulse.

55. A method as claimed in claim 46, wherein said optical fluoride crystal has a 200 to 210 nm range absorption coefficient <0.0017 cm⁻¹.
